(19) United States
(12) Patent Application Publication
(10) Pub. No.: US 2018/0193854 A1
(43) Pub. Date: Jul. 12, 2018

(54) Pressure Producing Device With A Portable Power Source

(71) Applicant: Brian Haney, Jefferson, GA (US)

(72) Inventor: Brian Haney, Jefferson, GA (US)

(21) Appl. No.: 15/701,036

(22) Filed: Sep. 11, 2017

Related U.S. Application Data
(60) Provisional application No. 62/385,600, filed on Sep. 9, 2016.

(51) Int. Cl. B05B 9/00; B08B 3/02

(52) U.S. Cl. CPC B05B 9/007; H02J 4/00; B08B 3/026

(57) ABSTRACT

A compression device that includes a motor, portable power source, and a housing to hold the motor and portable power source. The compression device compresses and releases fluids such as air or water. The portable power source is a single or dual high powered battery. The compression device has a power attachment to connect to an external power source if the portable power source is not used.

### CROSS REFERENCE TO RELATED APPLICATION

This application claims benefit to Provisional Application No. 62/385,600 filed Sep. 9, 2017, the entire contents of which are herein incorporated by reference.

### TECHNICAL FIELD

The technical field generally relates to battery powered pressurized devices, more specifically to a battery powered pressure washer and battery powered air compressor.

### BACKGROUND

Pressurized devices, such as pressure washers and air compressors, are well-known technologies used both commercially and by the everyday consumer. These devices, however, require a large amount of power to function. Pressure washers and air compressors are typically gas or electric powered. The electric powered devices, however, must be plugged into a dedicated power outlet.

This is both restrictive and cumbersome. For example, gas powered pressure devices are extremely heavy and noisy. It can be difficult to drag around the pressurized device to where it is needed. The noise can be a nuisance to both the users and others nearby, such as neighbors. Also, the user of the device is required to purchase gasoline to operate the device.

Current electric pressurized devices are restricted by the length of the electric cord. Extension cords must be purchased to each many areas where the pressurized device is needed. These extension cords typically must be heavy duty to handle the electrical output, and are thus expensive. Further, the cords themselves are cumbersome themselves. They get caught on corners, among other things, and can be difficult to maneuver.

### SUMMARY

Disclosed herein is pressure producing device powered by a portable power source.

In an embodiment, the device may include a housing, a direct connect source for providing material to dispose in the housing, a pressurizer, and a power source. In an aspect, the housing may be a housing for water. In another aspect, the housing may be a housing for compressed air. In an aspect, the pressurizer may be a pump or and compressor. The power source may be a battery. The battery may be detachable or may be built into the device. The battery may be a dual battery or it may include a switch to alternate power from between a DC power source or an AC power source. In an aspect, the housing may include a sliding mechanism so that the power source may slide on and off the housing. The compressor may be an air compressor, a pressure washer motor, or any other type of compressor that may fit with the scope of this invention. The device may have wheels or another similar component that allows the device to be easily transported. The device may have a handle or other means to maneuver the device. In as aspect, the device may include a power outlet or port so that the device may be plugged into a common power outlet or other external power source.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 is an exemplary illustration of a pressure device powered by a portable power source with a;

FIG. 2 is another exemplary illustration of a pressure device powered by a portable power source;

FIG. 3 is an exemplary illustration of components of pressure device powered by a portable power source;

FIG. 4 is another exemplary illustration of a pressure device powered by a portable power source;

FIG. 5 is another exemplary illustration of a pressure device powered by a portable power source; and

FIG. 6 an exemplary illustration of a pressure device powered by a portable power source for compressing air.

### DETAILED DESCRIPTION OF ILLUSTRATIVE EMBODIMENTS

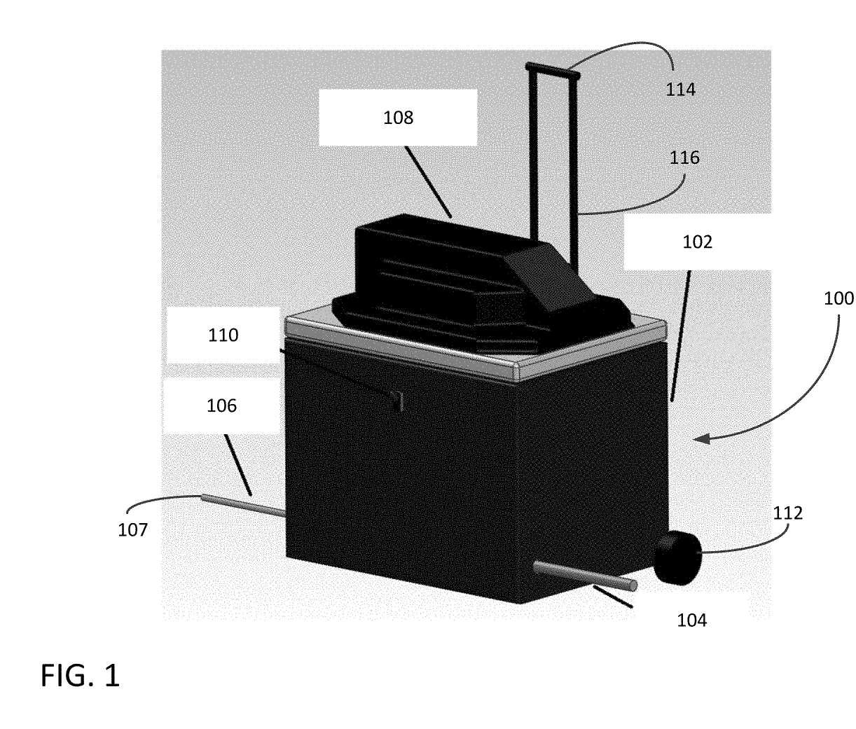

FIG. 1 is an exemplary illustration of a pressure device 100. As shown in FIG. 1, pressure device 100 may include housing 102, intake 104, outlet 106, outlet nozzle 107, portable power source 108, and power switch 110. Within housing 102 may be motor 112. Pressure device 100 may also include other features to facilitate ease of use or transportation, such as handle 114 and wheels 112

Housing 102 may be large enough to house motor 112. However, housing 102 should be small enough so that it may be portable. As an example, housing 102 may be the size of a large cooler. Housing 102 may be made of any type of durable material that can securely house motor 112. For example, housing 102 may made of a hard plastic, metal, carbon fiber, wood, and the like.

Intake 104 may be any input device that can receive a desired substance into motor 112. Similarly, outlet 106 may be any output device that can dispense a desired substance from motor 112. For example, intake 104 and outlet 106 may both be a type of hose for transporting a fluid substance in or out of motor 112. In an aspect, the fluid substance may be a gas. In another aspect, the fluid substance may be a liquid, such as, for example, water. Outlet nozzle 107 may be attached to the output end of outlet 106. Outlet nozzle 107 may be interchangeable and may dispense a desired substance in a certain way. It is contemplated that other types of intakes 104 and outlets 106 may be used that fit within the scope of this invention.

Motor 112 may be any type of pressure motor that fits within housing 102. For example, motor 112 may be a pressure washer motor. As an example, intake 104 receives the water and feeds it to the pressure water motor. The pressure washer motor pressurizes the water and dispenses it through outlet 106 and outlet nozzle 107. In other example, motor 112 may be an air compressor. Intake 104 receives air and feeds it to the air compressor motor. The air compressor motor pressurizes the air and dispenses it through outlet 106 and outlet nozzle 107. Outlet nozzle may be shaped to fit a certain fixture. For example, outlet nozzle may be shaped so that it may securely fit over a tire valve so that pressure device 100 may be used to fill a tire with air. Pressure device 100 may be used for multiple purposes similar to the previous example, such as discharging air pressure for all types of pneumatic tools.

Portable power source 108 may be mounted to the outside of housing 102 or it may fit securely within housing 102. Portable power source 108 need only be secured to housing 102 and provide power to motor 112. Portable power source 108 may be easily removable so that it can be replaced by another portable power source 108 if it runs out of power. Portable power source 108 may be a single or dual high powered batteries.

Power switch 110 may be any switch that is connected to motor 112 and can turn motor 110 on or off. Power switch 110 may be a switch, button, touch-free sensor, or any other similar mechanism for turning motor 112 on or off. In an example power switch 110 is connected to portable power source 108, and portable power source then turns on motor 112.

Handle 114 may be any component that would allow a user to grab and maneuver pressure device 100. For example, handle 114 may include two collapsible members 116 that can extend with a component connected to collapsible members 116, such as often seen in travel luggage. Handle 114 may also be built into housing 102, such as a hole or indentation long enough and deep enough so that a person's hands could fit inside. Handle 114 could also be a rope, cord, or the like that connects to housing 102 at both ends that may allow a person to grab and maneuver pressure device 100.

Wheels 112 may be any number of types of known wheels. For example, wheels 112 may be two cylindrical components on an axis that allows pressure device 100 to be maneuvered by being tilted. Wheels 112 may also by attached on a vertical axis so that they may be turned in any direction. Pressure device 100 may then comprise four or more wheels 112 and can be maneuvered without being tilted. It is contemplated that other types of known wheels can be used within the scope of the current invention.

In an example, motor 112 is a pressure washer motor. Intake 104 and outlet 106 are both hoses for transporting water. The intake hose may be connected to an external water source, such as a house connected to a water spigot at a person's home. The spigot may be opened so that water can freely flow toward the pressure washer motor. Power switch 110 is engaged to turn on the pressure washer motor. The pressure washer motor receives the water through intake 104, pressurizes the water, and dispenses it through outlet 106. Outlet nozzle 107 may be configured to dispense the water from outlet 106 in a particular manner. The pressure washer motor is powered by portable power source 108. If power source 108 runs out of power, power source 108 is easily removed and replaced with another power source 108. In a similar example, the external water source may be a water tank. In this and other examples, pressure device 100 can have wheels handle 114 and wheels 112 to facilitate transportation of the pressure device 100.

In an example, motor 112 is an air compressor motor. Intake 104 is an opening or something similar for receiving air into the air compressor motor and outlet 106 is a hose. Power switch 110 is engaged to turn on the air compressor motor. The air compressor motor receives the air through intake 104, pressurizes the air, and dispenses it through outlet 106. Outlet nozzle 107 may be configured to dispense the water from outlet 106 in a particular manner. For example, outlet nozzle may be shaped to fit securely over a tire valve so as to fill a tire with pressurized air. The air compressor is powered by portable power source 108. If portable power source 108 runs out of power, the battery is easily removed and replaced with another portable power source 108. In this and other examples, the pressure device 100 may have wheels handle 114 and wheels 112 to facilitate transportation of the pressure device 100.

The pressure device 100 may comprise an intake tube or a vacuum tube which may also double as an output tube. The tube may have a dry cleaning function and a wet cleaning function. The flow through the tube may be unidirectional or switch between intake and outtake. The tube may output a cleaning substance, such as detergent. The tube may output air. The tube may draw in debris or a cleaning substance, such as after it has been dispensed through the tube. The tube may be pressurized. The pressure may be adjusted. For example, the pressure may be adjusted from a negative pressure to a positive pressure. The magnitude of the pressure may be adjusted.

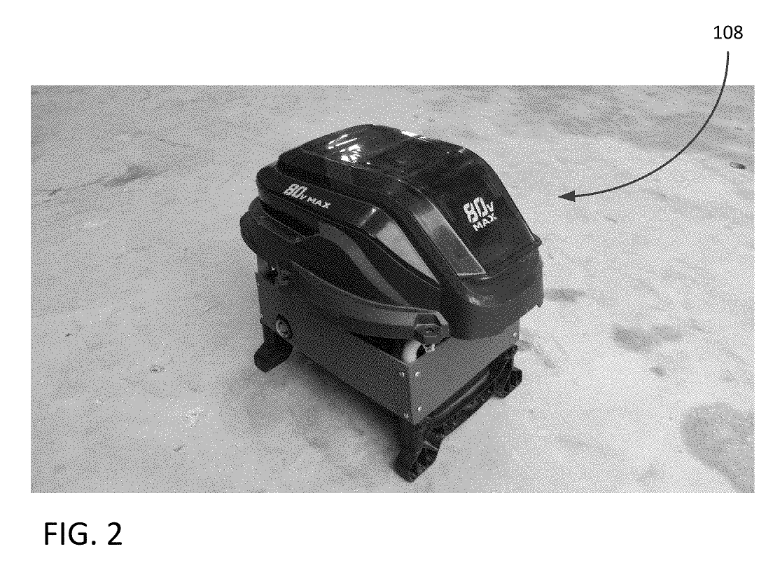

FIG. 2 is an exemplary embodiment of a portable power source 108. Portable power source 108 may be any type of power source that can fit on or inside housing 102, can power motor 112, and can be easily transported on or within housing 102. It is contemplated that portable power source 108 can operate without direct contact with an external power source, such plugging into a common power socket or wall plug. For example, portable power source 108 may be a single or dual high powered battery, such as a car battery or lithium ion battery. Portable power source 108 may be a rechargeable battery or other type of rechargeable power source. For example, portable power source 108 may be recharged by connecting it to an A/C power outlet. In another example, in the event that portable power source 108 runs out of power, portable power source 108 can remain connected to pressure device 100 and also connect to an A/C power outlet so that pressure device 100 may still be used even when portable power source 108 has no stored power. Portable power source 108 may additionally or alternatively be recharged by connecting it to a D/C power outlet.

Portable power source 108 may create around 80V as shown in FIG. 2. It is contemplated that portable power source 108 may create a greater amount of power so long as it is still portable. For example, and 160V or 320V power source would be better than an 80V power source so long as the 160V or 320 V power source is still portable. Technological developments allow electronic power sources to supply greater power and longer battery life within a smaller and lighter housing, it is contemplated that that more powerful and portable power sources may be used as the technology further develops.

While pressure device 100 may primarily be powered by portable power source 108, in an example, pressure device 100 may also be powered by a nonportable power source (not shown). For example, pressure device 100 may have a connection that will allow pressure device 100 to connect to an external power source via a power cable, such as a wall socket in a home, a gas powered engine, and the like. Such a power connection can serve as a backup in the instance that portable power source 108 runs out of power.

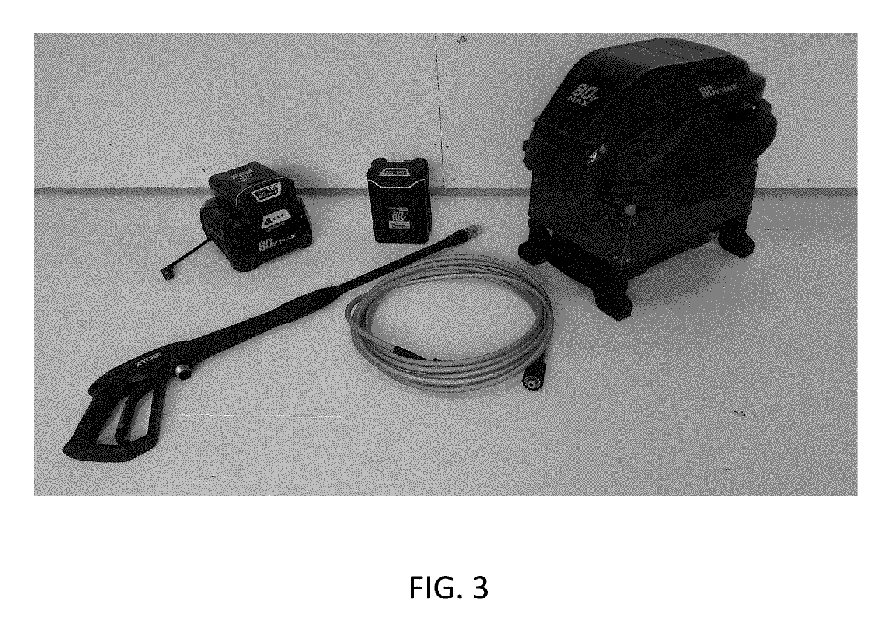

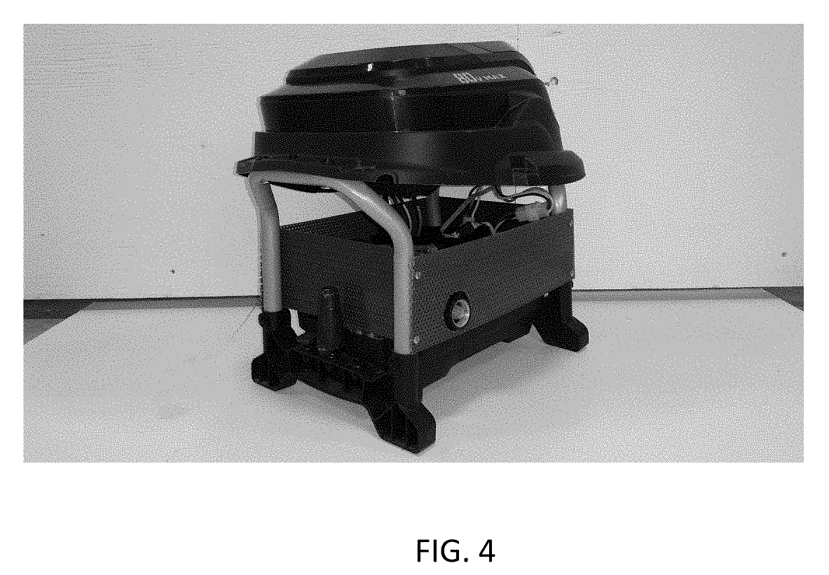

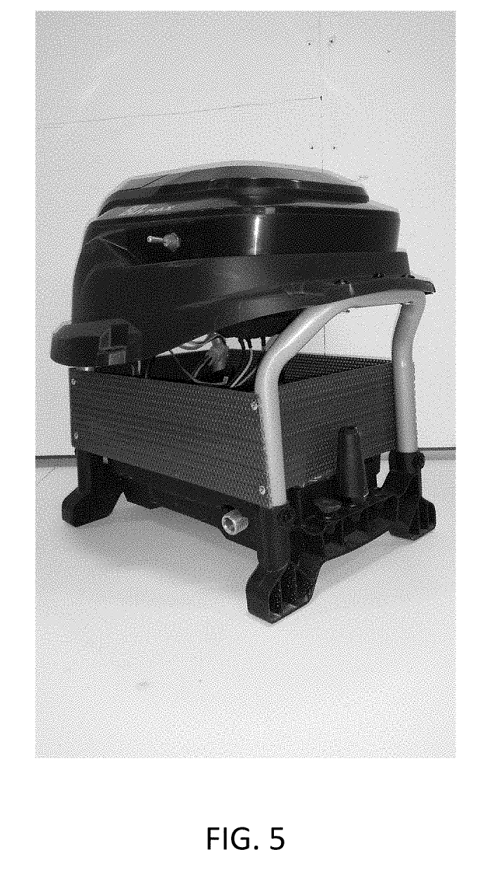

FIGS. 3-5 are exemplary illustrations of a pressure device 100 from different angles.

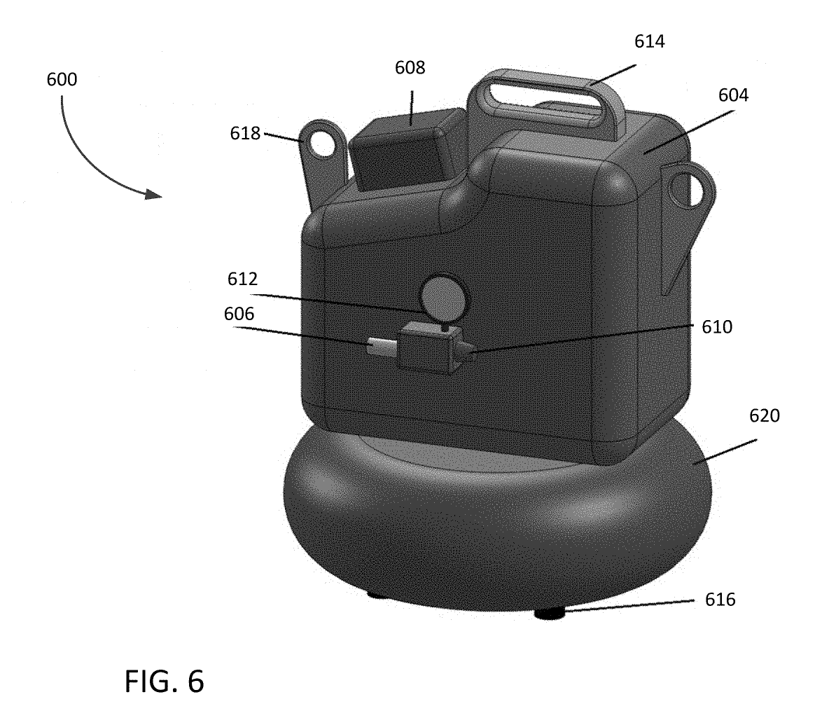

FIG. 6. is an exemplary illustration of a pressure device 600 powered by a portable power source 608 with an air tank 620. Pressure device 600 may also include housing 602, air pump 604, air hose attachment 606, pressure regulator knob 610, pressure gauge 612, handle 614, feet 616, and shoulder strap attachment loop 618.

Housing 602 may be large enough to house air pump 604. However, housing 602 should be small enough so that it may be portable. As an example, housing 602 may be the size of a large cooler. Housing 602 may be made of any type of durable material that can securely house air pump 604. For example, housing 602 may made of a hard plastic, metal, carbon fiber, wood, and the like.

Air hose attachment 606 may be any type of known device that an air hose (not shown) may securely attach to. Pressurized air may be released through air hose attachment 606. Pressure regulator knob 610 may regulate the amount of pressurized air released. Pressure gauge 612 may be any type of gauge that can measure the pressure within air tank 620. Air tank 620 may be any type of housing that can safely house pressurized air. It may be made of any type of durable material, such as durable plastic, metal, and the like, so long as it can safely store pressurized air.

Air pump 604 may be any type of pump that can pump air into air tank 620, creating pressurized air within air tank 620. Handle 614 may be any type of handle that will allow a person to carry pressure device 600. Feet 616 may be any type of support that helps keep pressure device 600 from tipping over and perhaps protect the floor on which pressure device 600 may be placed. For example, feet 616 may be 3 or more rubber attachments. Shoulder strap attachment loop 618 may be any type of loop in which an attachment strap may be inserted that that pressure device 600 may be carried by a person using a shoulder strap (not shown).

The pressure device 600 may be controlled by a switch. The switch may control the pressure of the air provided by the pressure device 600. For example, the switch may be configured to enable a user to set a maximum pressure or a minimum pressure, such as in pounds per square inch (PSI) or another unit of pressure. The pressure device 600 may be controlled by more than one switch. For example, a high power switch may control a maximum pressure and a low power switch may control a minimum pressure. Each switch may correspond to a different type of task to be performed by the pressure device 600. For example, based on the pressure required for a particular task, one of a plurality of switches may be used. The switch may be like the power switch 110. The switch may be configured to provide continually variable pressure between minimum and maximum pressure depending on the switch location.

The written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements.

What is claimed:

1. A device, comprising:
a pressure creating motor;
a portable power source connected to the pressure creating motor; and
a housing that houses the pressure creating motor and the portable power source.
